(19) United States
(12) Patent Application Publication
(10) Pub. No.: US 2026/0203396 A1
(43) Pub. Date: Jul. 16, 2026

(54) SYSTEM EVALUATION APPARATUS, SYSTEM EVALUATION METHOD, AND COMPUTER-READABLE RECORDING MEDIUM

(71) Applicant: NEC Corporation, Tokyo (JP)

(72) Inventors: Masahiro SUZUKI, Tokyo (JP); Anna ABE, Tokyo (JP); Yoshihiko KOIZUMI, Tokyo (JP)

(73) Assignee: NEC Corporation, Tokyo (JP)

(21) Appl. No.: 19/358,826

(22) Filed: Oct. 15, 2025

(30) Foreign Application Priority Data
Nov. 14, 2024 (JP) 2024-199117

(51) Int. Cl. G06F 21/55; G06F 21/57

(52) U.S. Cl. CPC G06F 21/55; G06F 21/577

(57) ABSTRACT

A system evaluation apparatus includes a generation unit for evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods, and an output unit for causing an output device to output vulnerability tendency information that represents a tendency of the vulnerability relevant to a worst evaluation result of the evaluation result information for each of the evaluation methods.

### CROSS REFERENCE TO RELATED APPLICATION

This application is based upon and claims the benefit of priority from Japanese patent application No. 2024-199117, filed on Nov. 14, 2024, the disclosure of which is incorporated herein in its entirety by reference.

### TECHNICAL FIELD

The present disclosure relates to a system evaluation apparatus, a system evaluation method, and a computer-readable recording medium for taking security measures.

### BACKGROUND ART

At present, a user (e.g., manager, security administrator, etc.) of an information technology (IT) system may not objectively and easily grasp detection and handling status of a vulnerability of the IT system, and may not easily take security measures autonomously.

As a related technique, PTL 1 (JP 2023-172405 A) discloses a risk-based authentication system that reduces processing time for risk assessment and resource consumption of a system used to carry out the risk assessment. The risk-based authentication system of JP 2023-172405 A includes an information processing apparatus that evaluates a risk of access to a resource by a client terminal and performs processing depending on an evaluation result.

### Citation List

In JP 2023-172405 A, the risk of access to a resource, such as a server, by the client terminal is evaluated using a plurality of risk determination methods. However, JP 2023-172405 A does not facilitate the grasping of the detection and handling status of the system vulnerability by the user (e.g., manager, security administrator, etc.), and does not facilitate the security measures.

### SUMMARY

An example of an object of the present disclosure is to facilitate grasping of detection and handling status of system security, and to facilitate security measures.

In order to achieve the object described above, a system evaluation apparatus according to an aspect of the present disclosure includes
a generation unit for evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods, and
an output unit for causing an output device to output vulnerability tendency information that represents a tendency of the vulnerability relevant to a worst evaluation result of the evaluation result information for each of the evaluation methods.

In order to achieve the object described above, a system evaluation method according to an aspect of the present disclosure causes
a computer to perform a process including
evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods, and
causing an output device to output vulnerability tendency information that represents a tendency of the vulnerability relevant to a worst evaluation result of the evaluation result information for each of the evaluation methods.

In order to achieve the object described above, a computer-readable recording medium according to an aspect of the present disclosure causes
a computer to perform a process including
evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods, and
causing an output device to output vulnerability tendency information that represents a tendency of the vulnerability relevant to a worst evaluation result of the evaluation result information for each of the evaluation methods.

As described above, according to the present disclosure, grasping of detection and handling status of system security may be facilitated, and security measures may be facilitated.

### BRIEF DESCRIPTION OF THE DRAWINGS

FIG. 1 is a diagram for explaining an example of a system evaluation apparatus;

FIG. 2 is a diagram illustrating an exemplary system including the system evaluation apparatus;

FIG. 3 is a graph for explaining an exemplary vulnerability of the system;

FIG. 4 is a table for explaining an example of system evaluation information;

FIG. 5 is a table for explaining determination of vulnerability tendency information;

FIG. 6 is a table for explaining exemplary system status display;

FIG. 7 is a flowchart for explaining exemplary operation of the system evaluation apparatus; and

FIG. 8 is a diagram for explaining an exemplary computer that achieves the system evaluation apparatus according to an example embodiment.

### EXAMPLE EMBODIMENT

Hereinafter, an example embodiment will be described with reference to the drawings. In the drawings to be described below, elements having the same function or relevant functions are denoted by the same reference signs, and repeated description thereof may be omitted.

### Example Embodiment

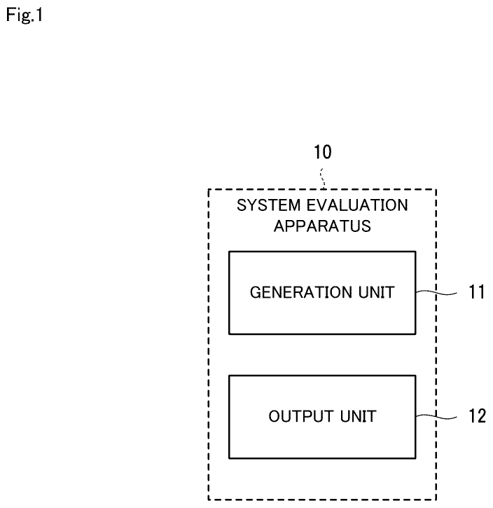

A configuration of a system evaluation apparatus according to an example embodiment will be described with reference to FIG. 1. FIG. 1 is a diagram for explaining an example of the system evaluation apparatus.

### [Apparatus Configuration]

The system evaluation apparatus illustrated in FIG. 1 is a device that facilitates grasping of detection and handling status of system security, and facilitates security measures. As illustrated in FIG. 1, a system evaluation apparatus 10 includes a generation unit 11 and an output unit 12.

The generation unit 11 evaluates a vulnerability status in a system for each of different types of evaluation methods using detection result information, which represents detection results of vulnerabilities of a plurality of information processing apparatuses (terminal devices) included in the system, and generates evaluation result information, which represents an evaluation result for each of the evaluation methods.

The output unit 12 causes an output device to output vulnerability tendency information representing, for example, a tendency of the vulnerability relevant to the worst evaluation result among the pieces of evaluation result information for the individual evaluation methods. The output unit 12 may output, to the output device, the vulnerability tendency information representing a tendency of the vulnerability to be monitored most attentively among the pieces of evaluation result information for the individual evaluation methods. Furthermore, the output unit 12 may select the evaluation result information satisfying a criterion for the attentive watching from among the pieces of evaluation result information for the individual evaluation methods, and may output the selected evaluation result information to the output device. When the evaluation result is represented by a numerical value representing a degree of urgency, examples of the criterion for the attentive watching include a value serving as a criterion for determining that the degree of urgency is high. When the evaluation result is represented by a character string representing a degree of attentive watching, examples of the criterion for the attentive watching include matching of the evaluation result with a character string indicating a class to be attentively watched.

As described above, according to the example embodiment, the vulnerability tendency information representing a tendency of the vulnerability relevant to the worst evaluation result among the pieces of evaluation result information for the individual evaluation methods is presented, whereby a user of the system (e.g., manager, security administrator, etc.) is enabled to easily grasp detection and handling status of the system security, and the security measures may be facilitated.

### [System Configuration]

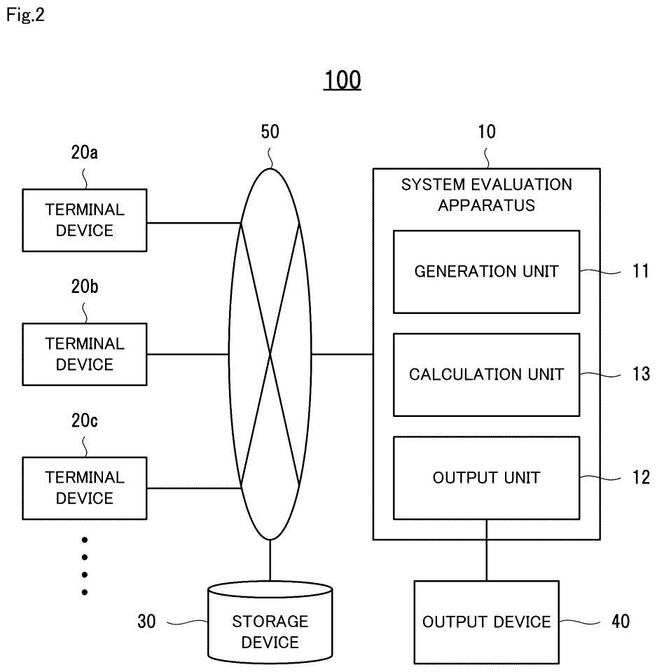

Next, the configuration of the system evaluation apparatus 10 according to the example embodiment will be more specifically described with reference to FIG. 2. FIG. 2 is a diagram illustrating an example of the system including the system evaluation apparatus.

As illustrated in FIG. 2, a system 100 according to the example embodiment includes at least the system evaluation apparatus 10, a plurality of information processing apparatuses 20 (20a, 20b, 20c, . . . ), a storage device 30, an output device 40, and a network 50.

The system evaluation apparatus 10 is an information processing apparatus such as a circuit, a server computer, a personal computer, a mobile terminal, or the like equipped with, for example, a central processing unit (CPU), a programmable device such as a field-programmable gate array (FPGA), a graphics processing unit (GPU), or any one or more of them.

The information processing apparatus 20 (20a, 20b, 20c, . . . ) is a terminal device such as a server computer, a personal computer, a mobile terminal, or the like equipped with, for example, a CPU, an FPGA, or both of them.

The storage device 30 is a circuit or the like including a database, a server computer, and a memory. The storage device 30 stores, for example, information such as detection result information, evaluation result information, a vulnerability risk level, criterion evaluation information, system evaluation information, and the like to be described later. While the storage device 30 is provided outside the system evaluation apparatus 10 in the example of FIG. 2, it may be provided inside the system evaluation apparatus 10.

The output device 40 obtains output information to be described later converted into a format that can be output, and outputs a generated image, sound, or the like based on the output information. Examples of the output device 40 include an image display device using a liquid crystal, an organic electro luminescence (EL), a cathode ray tube (CRT), or the like. Furthermore, the image display device may include, for example, an audio output device such as a speaker. The output device 40 may be a printing device such as a printer.

The network 50 is, for example, a general network constructed using a communication line, such as the Internet, a local area network (LAN), a dedicated line, a telephone line, an intra-company network, a mobile communication network, Bluetooth (registered trademark), Wireless Fidelity (Wi-Fi) (registered trademark), or the like.
The system evaluation apparatus will be described in detail.

The system evaluation apparatus 10 includes the generation unit 11, the output unit 12, and a calculation unit 13.

The generation unit 11 first obtains the detection result information, which is stored in the storage device 30 and represents the detection results of the vulnerabilities existing in the plurality of information processing apparatuses 20 included in the system 100.

The detection result information is log information, and at least includes information regarding a detected vulnerability and measures taken against the vulnerability. The detection result information is, for example, information regarding a vulnerability status of an operating system (OS; server OS and client OS) of the information processing apparatus 20, a detection and handling status for each system, a detection and handling status of the vulnerability of interest, a monthly vulnerability detection and handling status, an average number of days of handling, middleware modernization, a vulnerability status of the client OS, and the like.

Next, the generation unit 11 evaluates, using the obtained detection result information, the vulnerability status in the system 100 for each of the different types of evaluation methods, and generates evaluation result information, which represents an evaluation result for each of the evaluation methods.

As the evaluation result information for each of the evaluation methods, for example, the evaluation result information is generated using each of the following evaluation methods (1), (2), and (3).
(1) According to a first evaluation method, a score S1 (first evaluation result information), which represents a status of the system calculated using a total number Im of the information processing apparatuses (terminal devices) 20 managed by the system 100 and a total number Sm of the vulnerabilities of the information processing apparatuses 20 managed by the system 100, is generated. The score S1 may be expressed as Mathematical Expression 1.

### Mathematical Expression 1

S1=((Sm−1)/Im)×α
S1: Score (first evaluation result information)
Sm: Total number of vulnerabilities of terminal device
Im: Number of terminal devices
α: Weight

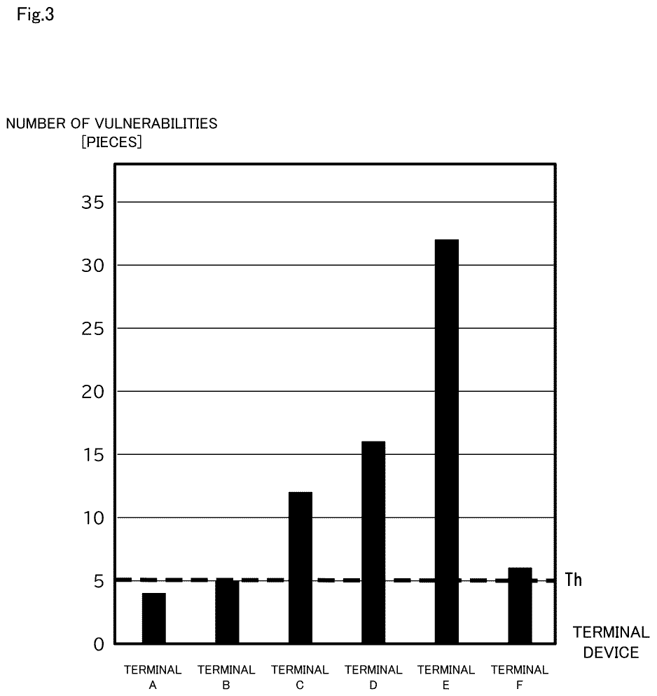

FIG. 3 is a graph for explaining an example of the vulnerability of the system. In the example of FIG. 3, there are six information processing apparatuses 20 (terminal devices) managed by the system 100, which are represented as terminals A to F. Accordingly, when the weight α is set to 10, the score S1 is 125 (=((4+5+12+16+32+7−1)/6)×10)=((76−1)/6)×10).

However, while the score S1 is suitable for a case where the number of vulnerabilities of each of the terminals A to F is approximately equal to each other (similar to each other), the score S1 may not accurately represent the status of the entire system when there are one terminal device having a larger (higher) number of vulnerabilities and a plurality of terminal devices having a smaller (lower) number of the vulnerabilities. For example, when the number of vulnerabilities of the one terminal device is 25 and the number of vulnerabilities of each of the plurality of other terminal devices is 1, the score S1 may not accurately represent the status of the system. In such a case, a second evaluation method is effective.
(2) According to the second evaluation method, in the system 100, a number Smm of vulnerabilities of the information processing apparatus 20, which is the most vulnerable, is set as a score S2 (second evaluation result information). The score S2 may be expressed as Mathematical Expression 2.

### Mathematical Expression 2

S2=(Smm−1)×β
S2: Score (second evaluation result information)
Smm: Number of vulnerabilities of most vulnerable terminal device
β: Weight

In the example of FIG. 3, among the plurality of information processing apparatuses (terminal devices) 20 managed by the system 100, the terminal E having the number Smm of vulnerabilities of 32 is detected as the riskiest terminal in the system 100. Thus, when the weight β is set to 10, the score S2 is 310 (=(32−1)×10).

Here, the score S2 may accurately represent the riskiest terminal device in the system when there are one terminal device having a larger (higher) number of vulnerabilities and a plurality of terminal devices having a smaller (lower) number of vulnerabilities. However, when there are a plurality of terminal devices having a larger (higher) number of vulnerabilities and a plurality of terminal devices having a smaller (lower) number of vulnerabilities, the score S2 may not represent the riskiest terminal device. That is, it may not indicate the existence of the plurality of other terminal devices having a larger (higher) number of vulnerabilities. For example, when the number of vulnerabilities of each of the plurality of terminal devices is equal to or more than 24 (larger) and the number of vulnerabilities of each of the plurality of terminal devices is equal to or less than 5 (smaller), the score S2 may not indicate that there is a plurality of risky terminal devices. In such a case, a third evaluation method is effective.
(3) According to the third evaluation method, the system 100 generates a score S3 (third evaluation result information), which represents a total number Imm of the information processing apparatuses 20 of which the number of vulnerabilities is equal to or more than a preset threshold Th. The score S3 may be expressed as Mathematical Expression 3.

The threshold Th may be determined by, for example, defining a risky terminal device, and is determined and changed from the vulnerability status (vulnerability handling maturity level of an organization) of the target information processing apparatus 20. For example, “a terminal device that has not addressed a vulnerability with a risk score 80 for equal to or more than two months” is defined as a risky terminal, and when two vulnerabilities with the risk score 80 are detected on average per month with respect to a terminal device, a terminal device having equal to or more than four vulnerabilities with the risk score 80 as a worse state is defined as a risky terminal device.

### Mathematical Expression 3

S3=Imm×γ
S3: Score (third evaluation result information)
Imm: Number of terminal devices of which the number of vulnerabilities is equal to or more than the threshold Th
γ: Weight

In the example of FIG. 3, the threshold Th is set to five, and thus the terminals C to F of which the number Smm of vulnerabilities is equal to or more than five are detected as risky terminal devices among the plurality of information processing apparatuses (terminal devices) 20 managed by the system 100. Thus, when the weight γ is set to 40, the score S3 is 160 (=4×40).

The score S3 may accurately represent the number of risky terminal devices in the system 100 when there are many terminal devices of which the number of vulnerabilities is equal to or more than the threshold Th and is close to the threshold Th (e.g., when there are five terminal devices of which the number of vulnerabilities is equal to or more than the threshold Th, and the number of vulnerabilities is close to the threshold Th in five of the terminal devices, etc.). However, the score S3 may not accurately represent the number of risky terminal devices when there are many terminal devices of which the number of vulnerabilities is equal to or more than the threshold Th and is not close to the threshold Th, for example, when there are five terminal devices of which the number of vulnerabilities is equal to or more than the threshold Th, and the number of vulnerabilities is around ten in four of the terminal devices while the number of vulnerabilities exceeds 32 in one terminal device. In that case, the second evaluation method is effective.

The weights α, β, and γ described above are set in advance to differentiate the system evaluation information for each risk level of the system 100 to be described later. That is, in order to differentiate the system evaluation information for each risk level of the system, the preset weights α, β, and γ are applied to calculate first evaluation information, second evaluation information, and third evaluation information.

The weights α, β, and γ are basically set in such a way that there is a case where the individual values of the scores S1, S2, and S3 are maximized to grasp the vulnerability tendency. The weighting is changed according to a situation of an introduction environment and a security measures policy in compliance with the policy described above. For example, when a very large number of terminal devices are managed in each system, and existence of a large number of risky terminal devices is considered to pose a higher risk, the value of γ is set to be larger. Alternatively, it is conceivable to set the value of β to be larger in a case where there is a terminal device adopting special software and it is desired to facilitate grasping when a vulnerability is confirmed with respect to the software. Since α is given to weight the risk score 60 as in the case of the risk score 80 when calculating a score as to how many vulnerabilities exist per device, α >1.0 needs to be satisfied.

The calculation unit 13 integrates the criterion evaluation information (base score SB) relevant to the vulnerability risk level (risk score) set for the system 100 and the evaluation result information (scores S1, S2, and S3) for each evaluation method, and generates system evaluation information (total score ST) representing an evaluation of the system.

The vulnerability risk level is a risk score that represents a level of the vulnerability present in the system 100. The risk score may be divided into levels of, for example, 100, 80, 60, and the like. However, the risk score is not limited to the score described above.

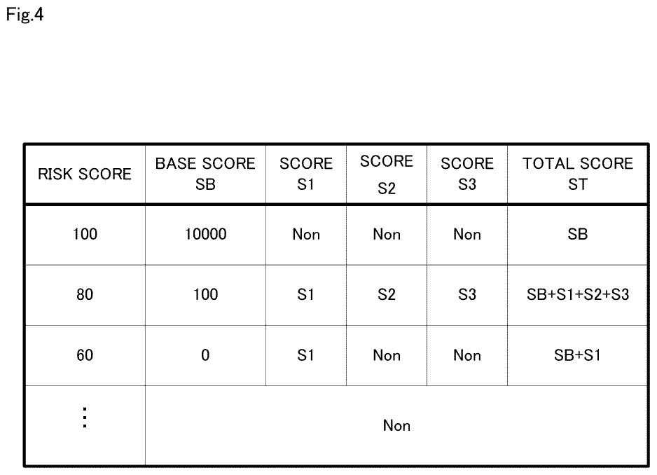

The criterion evaluation information is a score (base score) set in advance for the vulnerability risk level (risk score). FIG. 4 is a table for explaining an example of the system evaluation information. In the example of FIG. 4, in the criterion evaluation information, “10,000” is associated as a base score when the risk score is “100”, “100” is associated as a base score when the risk score is “80”, and “0” is associated as a base score when the risk score is equal to or less than “60”. However, the method of setting the criterion evaluation information is not limited to the method described above.

As for the base score, for example, a case is rarely observed in which equal to or more than 100 vulnerabilities with the risk score 60 are newly detected for one terminal in one month, and a case is frequently observed in which a vulnerability with the risk score 80 is detected when the terminal is left for equal to or more than two months, and thus the base score of the risk score 80 is set to “100” or the like. When computation is carried out for an actual system after setting α=10, β=10, and γ=40 as weights in the system having a vulnerability of the risk score 80, there is no system having a total score exceeding “10,000”, and accordingly, it is conceivable to set the base score of the risk score 100 to “10,000”. That is, the base score is set in such a way that it is larger when at least one risk score 100 is present than that in a case where a considerable number of risk scores 80 are present.

In the example of FIG. 4, when the risk score is “100”, the system evaluation information (total score ST) is set to be the base score SB. In that case, the total score ST is “10,000”. When the risk score is “80”, the total score ST is a value obtained by adding the base score SB and the scores S1, S2, and S3 (=SB+S1+S2+S3). When the risk score is “60”, the total score ST is a value obtained by adding the base score SB and the score S1 (=SB+S1).

The output unit 12 first determines the vulnerability tendency information, which represents a tendency of the vulnerability, based on the evaluation result information (scores S1, S2, and S3) for each evaluation method.

Next, the output unit 12 converts at least the vulnerability tendency information and the system evaluation information (total score ST) for each system into a format that can be output to generate output information, transmits the output information to the output device 40, and causes the output device 40 to output the vulnerability tendency information and the system evaluation information. The output device 40 may be caused to output, for each system, a category name, risk score, deadline for an action, and the like of the system. Conceivable examples of the “category name” include “finance”, “security”, and the like.

### Risk Score 100

In the case of the highest vulnerability risk level (in the case of the risk score 100), the output unit 12 outputs, to the output device 40, text information indicating necessity of an urgent action as the vulnerability tendency information.

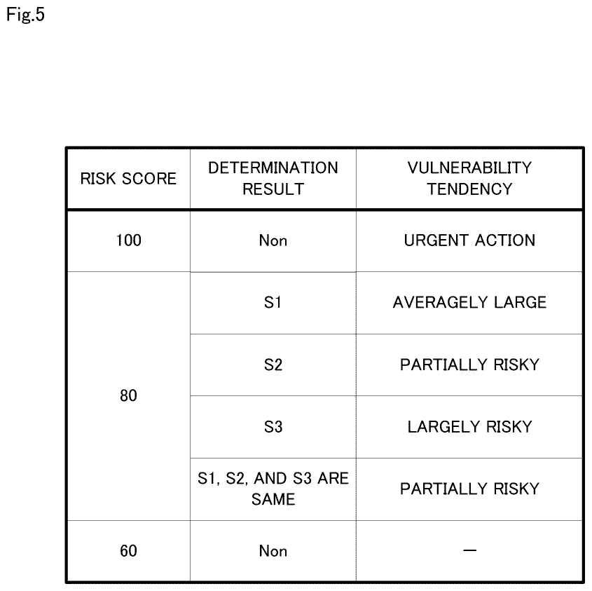

FIG. 5 is a table for explaining determination of the vulnerability tendency information. In the example of FIG. 5, in the case of the risk score 100, “urgent action” is selected as the vulnerability tendency information.

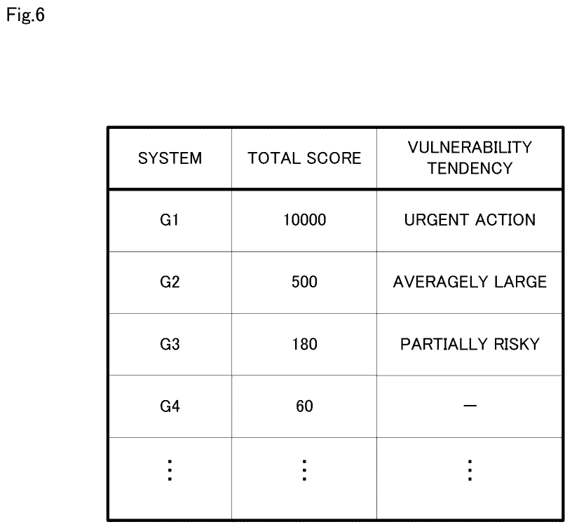

FIG. 6 is a table for explaining exemplary system status display. In the example of FIG. 6, the output device 40 is caused to output the vulnerability tendency information “urgent action” and the system evaluation information (total score ST) in association with system identification information “G1” for identifying the system. For example, “within seven days from the action request” or the like may be further output as a deadline for an action.

### Risk Score 80

### (A) Vulnerability Tendency of Score S1

The output unit 12 causes the output device 40 to output first vulnerability tendency information relevant to the first evaluation result information (score S1) when an evaluation value of the first evaluation result information (score S1) is higher than that of the second evaluation result information (score S2) and the third evaluation result information (score S3) and the second evaluation result information (score S2) and the third evaluation result information (score S3) fall within a similar range.

The similar range indicates a range set in advance to determine whether the scores are similar.

Specifically, even in the case of S2<S3 or S2<S1, a message associated with S2 is displayed as a tendency of the vulnerability when S2+ΔS2≥S3 or S2+ΔS2≥S1 is satisfied. Here, ΔS2 is assumed to represent, for example, a value of S2 that increases in one month (ΔS2=A1×β).

Even in the case of S3<S1, a message associated with S3 is displayed as a tendency of the vulnerability when S3 +ΔS3≥S1 is satisfied. Here, ΔS3 is defined as follows. ΔS3 is assumed to represent, for example, a value of S3 that increases in one month (ΔS3=A2×γ).

S1 represents a score calculated from the number of vulnerabilities of the risk score 80 present per device. S2 represents a score calculated from the number of vulnerabilities of the risk score 80 present in the riskiest terminal. S3 represents a score calculated from the number of risky terminals.

It is assumed that β=weight of S2, γ=weight of S3, and Th=threshold. A1 is assumed to be the average number of times of detection of the risk score 80 per month for one terminal device. A2 is assumed to be the number of terminals in the system having [equal to or more than (Th−A1) and less than Th] items matching the vulnerability of the risk score 80. ΔS2 and ΔS3 may be determined and changed from the vulnerability status (vulnerability handling maturity level of the organization) of the target information processing apparatus.

The first vulnerability tendency information is text information indicating that the number of vulnerabilities is averagely large. For example, the first text information outputs, to the output device 40, text such as “averagely large”, “averagely high”, or the like. However, the first text is not limited to the text described above.

In the example of FIG. 5, in the case of the risk score 80, “averagely large” is selected as the vulnerability tendency information. In the example of FIG. 6, the output device 40 is caused to output the vulnerability tendency information “averagely large” and the system evaluation information (total score ST) “500” in association with system identification information “G2” for identifying the system. For example, text such as “within 14 days from the action request” may be further displayed as a deadline for an action.

### (B) Vulnerability Tendency of Score S2

The output unit 12 causes the output device 40 to output second vulnerability tendency information relevant to the second evaluation result information (score S2) when an evaluation value of the second evaluation result information (score S2) is higher than that of the first evaluation result information (score S1) and the third evaluation result information (score S3) and the first evaluation result information (score S1) and the third evaluation result information (score S3) fall within a similar range.

The second vulnerability tendency information is text information indicating existence of the information processing apparatus 20 of which the number of vulnerabilities is in a risk range. For example, the second text information displays text such as “partially risky” on the output device 40. However, the second text is not limited to the text described above.

In the example of FIG. 5, in the case of the risk score 80, “partially risky” is selected as the vulnerability tendency information. In the example of FIG. 6, the output device 40 is caused to output the vulnerability tendency information “partially risky” and the system evaluation information (total score ST) “180” in association with system identification information “G3” for identifying the system. For example, text such as “within 14 days from the action request” may be further displayed as a deadline for an action.

### (C) Vulnerability Tendency of Score S3

The output unit 12 causes the output device 40 to output third vulnerability tendency information relevant to the third evaluation result information (score S3) when an evaluation value of the third evaluation result information (score S3) is higher than that of the first evaluation result information (score S1) and the second evaluation result information (score S2) and the first evaluation result information (score S1) and the second evaluation result information (score S2) fall within a similar range.

The third vulnerability tendency information is text information indicating that equal to or more than a preset number of the information processing apparatuses 20 having a larger number of vulnerabilities exist. For example, the third text information displays text such as “largely risky” on the output device 40. However, the third text is not limited to the text described above.

In the example of FIG. 5, in the case of the risk score 80, “largely risky” is selected as the vulnerability tendency information. In the example of FIG. 6, the output device 40 is caused to output the system evaluation information (total score ST) “60” in association with system identification information “G4” for identifying the system without displaying the vulnerability tendency information. For example, text such as “within 14 days from the action request” may be further displayed as a deadline for an action.

(D) Vulnerability Tendency when Scores are Similar

The output unit 12 outputs the second vulnerability tendency information relevant to the second evaluation result information when the first evaluation result information, the second evaluation result information, and the third evaluation result information are the same. For example, text such as “partially risky” is displayed on the output device 40. For example, text such as “within 14 days from the action request” may be further displayed as a deadline for an action. Depending on the risk value, priority levels in the case of being the same are assumed to be “partially risky” >“largely risky”>“averagely large”.

### Risk Score 60

In the case of the lowest vulnerability risk level (in the case of the risk score 60), the output unit 12 outputs a deadline for an action to the output device 40, and does not output a vulnerability tendency. For example, text such as “within 30 days from the action request” may be further displayed as a deadline for an action. However, the vulnerability tendency may be output to the output device 40.

### [Apparatus Operation]

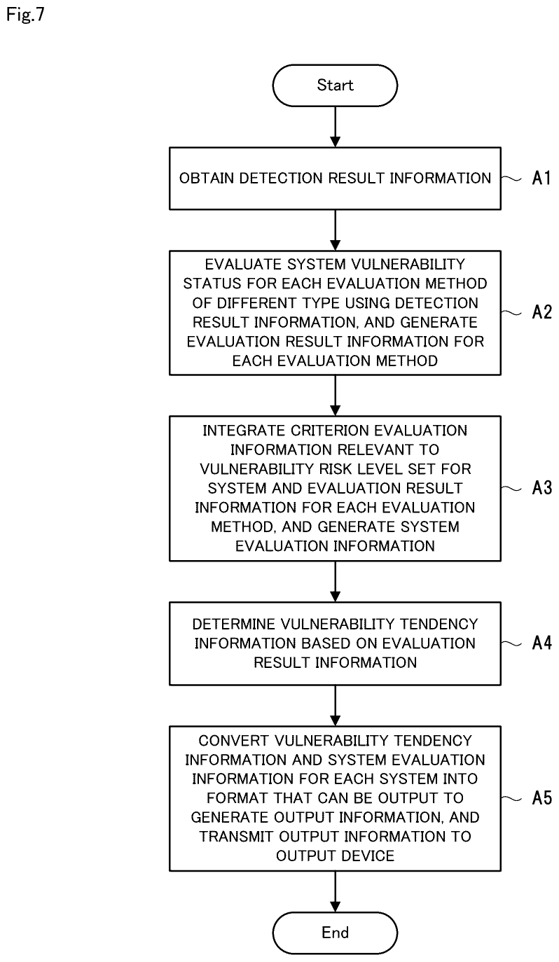

Next, an operation of the system evaluation apparatus according to the example embodiment will be described with reference to FIG. 7. FIG. 7 is a flowchart for explaining exemplary operation of the system evaluation apparatus. The drawing will be appropriately referred to in the following descriptions. In the example embodiment, a system evaluation method is implemented by the system evaluation apparatus being operated. Thus, descriptions of the system evaluation method according to the example embodiment are substituted with the following descriptions regarding the operation of the system evaluation apparatus.

As illustrated in FIG. 7, the generation unit 11 first obtains the detection result information, which is stored in the storage device 30 and represents the detection results of the vulnerabilities existing in the plurality of information processing apparatuses 20 included in the system 100 (step A1).

Next, the generation unit 11 evaluates, using the obtained detection result information, the vulnerability status in the system 100 for each of the different types of evaluation methods, and generates evaluation result information, which represents an evaluation result for each of the evaluation methods (step A2). In step A2, the evaluation result information (scores S1, S2, and S3) is generated using each of the evaluation methods (1), (2), and (3) described above.

Next, the calculation unit 13 integrates the criterion evaluation information (base score SB) relevant to the vulnerability risk level (risk score) set for the system 100 and the evaluation result information (scores S1, S2, and S3) for each evaluation method, and generates system evaluation information (total score ST) representing an evaluation of the system (step A3).

Next, the output unit 12 determines the vulnerability tendency information, which represents a tendency of the vulnerability, based on the evaluation result information (scores S1, S2, and S3) for each evaluation method (step A4).

Next, the output unit 12 converts at least the vulnerability tendency information and the system evaluation information (total score ST) for each system into a format that can be output to generate output information, and transmits the output information to the output device 40 (step A5). Thereafter, the vulnerability tendency information and the system evaluation information are output to the output device 40. The output device 40 may be caused to output, for each system, a category name, risk score, deadline for an action, and the like of the system.

### [Effects of Example Embodiment]

As described above, according to the example embodiment, the vulnerability tendency information representing a tendency of the vulnerability relevant to the evaluation result for each evaluation method and the system evaluation information (total score ST) are presented, whereby the user of the system (e.g., manager, security administrator, etc.) is enabled to easily grasp the detection and handling status of the system security, and the security measures may be facilitated.

### [Program]

A program in the example embodiment only needs to be a program that causes a computer to execute steps A1 to A5 illustrated in FIG. 7. With the program being installed and executed in the computer, the system evaluation apparatus and the system evaluation method according to the example embodiment may be implemented. In that case, a processor of the computer functions as the generation unit 11, the output unit 12, and the calculation unit 13 to perform processing.

The program in the example embodiment may be executed by a computer system including a plurality of computers. In that case, for example, each of the computers may function as any of the generation unit 11, the output unit 12, and the calculation unit 13.

### [Physical Configuration]

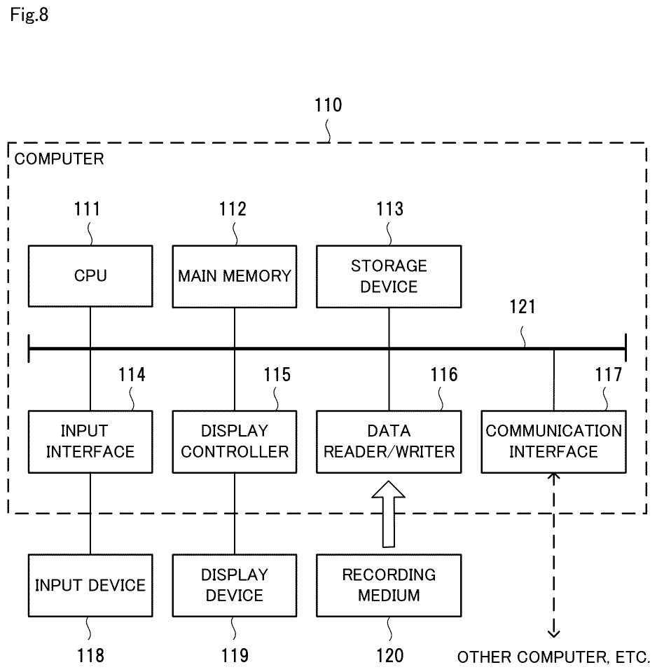

Here, with reference to FIG. 8, the computer will be described in which the system evaluation apparatus is implemented by the program in the example embodiment being executed. FIG. 8 is a diagram for explaining an example of the computer that achieves the system evaluation apparatus according to an example embodiment.

As illustrated in FIG. 8, a computer 110 includes a central processing unit (CPU) 111, a main memory 112, a storage device 113, an input interface 114, a display controller 115, a data reader/writer 116, and a communication interface 117. Those units are data-communicably connected to each other via a bus 121. The computer 110 may include a GPU or an FPGA in addition to the CPU 111 or instead of the CPU 111.

The CPU 111 loads the program according to the example embodiment, which is stored in the storage device 113 and includes codes, into the main memory 112, and executes each code in a predetermined order, thereby performing various operations. The main memory 112 is typically a volatile storage device such as a dynamic random access memory (DRAM).

The program in the example embodiment is provided in a state of being stored in a computer-readable recording medium 120. The program in the example embodiment may be distributed on the Internet connected via the communication interface 117.

Specific examples of the storage device 113 include a semiconductor storage device, such as a flash memory, in addition to a hard disk drive. The input interface 114 mediates data transmission between the CPU 111 and an input device 118 such as a keyboard and a mouse. The display controller 115 is connected to a display device 119, and controls display on the display device 119.

The data reader/writer 116 mediates data transmission between the CPU 111 and the recording medium 120, reads a program from the recording medium 120, and writes a processing result of the computer 110 into the recording medium 120. The communication interface 117 mediates data transmission between the CPU 111 and another computer.

Specific examples of the recording medium 120 include a general-purpose semiconductor storage device such as Compact Flash (CF) (registered trademark) or Secure Digital (SD), a magnetic recording medium such as a flexible disk, and an optical recording medium such as a compact disk read only memory (CD-ROM).

The system evaluation apparatus 10 according to the example embodiment may also be achieved by using hardware related to each unit, for example, an electronic circuit, instead of the computer in which the program is installed. Moreover, a part of the system evaluation apparatus 10 may be achieved by a program, and the remaining part may be achieved by hardware. In the example embodiment, the computer is not limited to the computer illustrated in FIG. 8.

### [Supplementary Note]

With regard to the above example embodiment, the following Supplementary Notes are further disclosed. A part or whole of the example embodiment described above may be expressed by the following (Supplementary Note 1) to (Supplementary Note 33), but is not limited to the following description.

### (Supplementary Note 1)

A system evaluation apparatus including:
a generation unit for evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods; and
an output unit for causing an output device to output vulnerability tendency information that represents a tendency of the vulnerability relevant to a worst evaluation result of the evaluation result information for each of the evaluation methods.

### (Supplementary Note 2)

The system evaluation apparatus according to Supplementary Note 1, further including:
a calculation unit for integrating criterion evaluation information relevant to a risk level of the vulnerability set for the system and the evaluation result information for each of the evaluation methods and generating system evaluation information that represents an evaluation of the system.

### (Supplementary Note 3)

The system evaluation apparatus according to Supplementary Note 2, in which
the evaluation result information for each of the evaluation methods includes:
first evaluation result information that represents a value calculated using a number of the information processing apparatuses and a number of the vulnerabilities of the system;
second evaluation result information that represents the number of vulnerabilities included in a most vulnerable information processing apparatus in the system; and
third evaluation result information that represents the number of information processing apparatuses in which the number of vulnerabilities is equal to or more than a preset threshold in the system.

### (Supplementary Note 4)

The system evaluation apparatus according to Supplementary Note 3, in which
the output unit is configured to:
output second vulnerability tendency information relevant to the second evaluation result information when the first evaluation result information, the second evaluation result information, and the third evaluation result information are the same.

### (Supplementary Note 5)

The system evaluation apparatus according to Supplementary Note 3, in which
the output unit is configured to:
output first vulnerability tendency information relevant to the first evaluation result information when an evaluation value of the first evaluation result information is higher than the evaluation value of the second evaluation result information and the third evaluation result information and the second evaluation result information and the third evaluation result information fall within a similar range.

### (Supplementary Note 6)

The system evaluation apparatus according to Supplementary Note 3, in which
the output unit is configured to:
output second vulnerability tendency information relevant to the second evaluation result information when an evaluation value of the second evaluation result information is higher than the evaluation value of the first evaluation result information and the third evaluation result information and the first evaluation result information and the third evaluation result information fall within a similar range.

### (Supplementary Note 7)

The system evaluation apparatus according to Supplementary Note 3, in which
the output unit is configured to:
output third vulnerability tendency information relevant to the third evaluation result information when an evaluation value of the third evaluation result information is higher than the evaluation value of the first evaluation result information and the second evaluation result information and the first evaluation result information and the second evaluation result information fall within a similar range.

### (Supplementary Note 8)

The system evaluation apparatus according to Supplementary Note 3, in which
the generation unit is configured to:
calculate the first evaluation result information, the second evaluation result information, and the third evaluation result information by applying a preset weight to differentiate the system evaluation information for each of the risk levels of the system.

### (Supplementary Note 9)

The system evaluation apparatus according to Supplementary Note 5, in which
the first vulnerability tendency information includes text information indicating that the number of vulnerabilities is averagely large.

### (Supplementary Note 10)

The system evaluation apparatus according to Supplementary Note 6, in which
the second vulnerability tendency information includes text information indicating that the information processing apparatus in which the number of vulnerabilities is in a risk range is present.

### (Supplementary Note 11)

The system evaluation apparatus according to Supplementary Note 7, in which
the third vulnerability tendency information includes text information indicating that equal to or more than a preset number of the information processing apparatuses in which the number of vulnerabilities is large are present.

### (Supplementary Note 12)

A system evaluation method causing a computer to perform a process including:
evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods; and
causing an output device to output vulnerability tendency information that represents a tendency of the vulnerability relevant to a worst evaluation result of the evaluation result information for each of the evaluation methods.

### (Supplementary Note 13)

The system evaluation method according to Supplementary Note 12, the method causing the computer to perform the process further including:
integrating criterion evaluation information relevant to a risk level of the vulnerability set for the system and the evaluation result information for each of the evaluation methods and generating system evaluation information that represents an evaluation of the system.

### (Supplementary Note 14)

The system evaluation method according to Supplementary Note 13, in which
the evaluation result information for each of the evaluation methods includes:
first evaluation result information that represents a value calculated using a number of the information processing apparatuses and a number of the vulnerabilities of the system;
second evaluation result information that represents the number of vulnerabilities included in a most vulnerable information processing apparatus in the system; and
third evaluation result information that represents the number of information processing apparatuses in which the number of vulnerabilities is equal to or more than a preset threshold in the system.

### (Supplementary Note 15)

The system evaluation method according to Supplementary Note 14, the method causing
the computer to perform the process further including:
outputting second vulnerability tendency information relevant to the second evaluation result information when the first evaluation result information, the second evaluation result information, and the third evaluation result information are the same.

### (Supplementary Note 16)

The system evaluation method according to Supplementary Note 14, the method causing
the computer to perform the process further including:
outputting first vulnerability tendency information relevant to the first evaluation result information when an evaluation value of the first evaluation result information is higher than the evaluation value of the second evaluation result information and the third evaluation result information and the second evaluation result information and the third evaluation result information fall within a similar range.

### (Supplementary Note 17)

The system evaluation method according to Supplementary Note 14, the method causing
the computer to perform the process further including:
outputting second vulnerability tendency information relevant to the second evaluation result information when an evaluation value of the second evaluation result information is higher than the evaluation value of the first evaluation result information and the third evaluation result information and the first evaluation result information and the third evaluation result information fall within a similar range.

### (Supplementary Note 18)

The system evaluation method according to Supplementary Note 14, the method causing
the computer to perform the process further including:
outputting third vulnerability tendency information relevant to the third evaluation result information when an evaluation value of the third evaluation result information is higher than the evaluation value of the first evaluation result information and the second evaluation result information and the first evaluation result information and the second evaluation result information fall within a similar range.

### (Supplementary Note 19)

The system evaluation method according to Supplementary Note 14, the method causing
the computer to perform the process further including:
calculating the first evaluation result information, the second evaluation result information, and the third evaluation result information by applying a preset weight to differentiate the system evaluation information for each of the risk levels of the system.

### (Supplementary Note 20)

The system evaluation method according to Supplementary Note 16, in which
the first vulnerability tendency information includes text information indicating that the number of vulnerabilities is averagely large.

### (Supplementary Note 21)

The system evaluation method according to Supplementary Note 17, in which
the second vulnerability tendency information includes text information indicating that the information processing apparatus in which the number of vulnerabilities is in a risk range is present.

### (Supplementary Note 22)

The system evaluation method according to Supplementary Note 18, in which
the third vulnerability tendency information includes text information indicating that equal to or more than a preset number of the information processing apparatuses in which the number of vulnerabilities is large are present.

### (Supplementary Note 23)

A program for causing
a computer to perform a process including:
evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods; and
causing an output device to output vulnerability tendency information that represents a tendency of the vulnerability relevant to a worst evaluation result of the evaluation result information for each of the evaluation methods.

### (Supplementary Note 24)

The program according to Supplementary Note 23, the program causing
the computer to perform the process further including:
integrating criterion evaluation information relevant to a risk level of the vulnerability set for the system and the evaluation result information for each of the evaluation methods and generating system evaluation information that represents an evaluation of the system.

### (Supplementary Note 25)

The program according to Supplementary Note 24, in which
the evaluation result information for each of the evaluation methods includes:
first evaluation result information that represents a value calculated using a number of the information processing apparatuses and a number of the vulnerabilities of the system;
second evaluation result information that represents the number of vulnerabilities included in a most vulnerable information processing apparatus in the system; and
third evaluation result information that represents the number of information processing apparatuses in which the number of vulnerabilities is equal to or more than a preset threshold in the system.

### (Supplementary Note 26)

The program according to Supplementary Note 25, the program causing
the computer to perform the process further including:
outputting second vulnerability tendency information relevant to the second evaluation result information when the first evaluation result information, the second evaluation result information, and the third evaluation result information are the same.

### (Supplementary Note 27)

The program according to Supplementary Note 25, the program causing
the computer to perform the process further including:
outputting first vulnerability tendency information relevant to the first evaluation result information when an evaluation value of the first evaluation result information is higher than the evaluation value of the second evaluation result information and the third evaluation result information and the second evaluation result information and the third evaluation result information fall within a similar range.

### (Supplementary Note 28)

The program according to Supplementary Note 25, the program causing
the computer to perform the process further including:
outputting second vulnerability tendency information relevant to the second evaluation result information when an evaluation value of the second evaluation result information is higher than the evaluation value of the first evaluation result information and the third evaluation result information and the first evaluation result information and the third evaluation result information fall within a similar range.

### (Supplementary Note 29)

The program according to Supplementary Note 25, the program causing
the computer to perform the process further including:
outputting third vulnerability tendency information relevant to the third evaluation result information when an evaluation value of the third evaluation result information is higher than the evaluation value of the first evaluation result information and the second evaluation result information and the first evaluation result information and the second evaluation result information fall within a similar range.

### (Supplementary Note 30)

The program according to Supplementary Note 25, the program causing
the computer to perform the process further including:
calculating the first evaluation result information, the second evaluation result information, and the third evaluation result information by applying a preset weight to differentiate the system evaluation information for each of the risk levels of the system.

### (Supplementary Note 31)

The program according to Supplementary Note 27, in which
the first vulnerability tendency information includes text information indicating that the number of vulnerabilities is averagely large.

### (Supplementary Note 32)

The program according to Supplementary Note 28, in which
the second vulnerability tendency information includes text information indicating that the information processing apparatus in which the number of vulnerabilities is in a risk range is present.

### (Supplementary Note 33)

The program according to Supplementary Note 29, in which
the third vulnerability tendency information includes text information indicating that equal to or more than a preset number of the information processing apparatuses in which the number of vulnerabilities is large are present.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

### INDUSTRIAL APPLICABILITY

According to the descriptions above, grasping of detection and handling status of system security may be facilitated, and security measures may be facilitated. It is useful in a field that requires vulnerability analysis.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

1. A system evaluation apparatus comprising:
at least one memory storing instructions; and
at least one processor configured to execute the instructions to:
evaluate, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods; and
cause an output device to output vulnerability tendency information that represents a tendency of the vulnerability relevant to a worst evaluation result of the evaluation result information for each of the evaluation methods.

2. The system evaluation apparatus according to claim 1,
wherein the one or more processors further:
integrate criterion evaluation information relevant to a risk level of the vulnerability set for the system and the evaluation result information for each of the evaluation methods and generating system evaluation information that represents an evaluation of the system.

3. The system evaluation apparatus according to claim 2, wherein
the evaluation result information for each of the evaluation methods includes:
first evaluation result information that represents a value calculated using a number of the information processing apparatuses and a number of the vulnerabilities of the system;
second evaluation result information that represents the number of vulnerabilities included in a most vulnerable information processing apparatus in the system; and
third evaluation result information that represents the number of information processing apparatuses in which the number of vulnerabilities is equal to or more than a preset threshold in the system.

4. The system evaluation apparatus according to claim 3,
wherein the one or more processors further:
output second vulnerability tendency information relevant to the second evaluation result information when the first evaluation result information, the second evaluation result information, and the third evaluation result information are the same.

5. The system evaluation apparatus according to claim 4,
wherein the one or more processors further:
output first vulnerability tendency information relevant to the first evaluation result information when an evaluation value of the first evaluation result information is higher than the evaluation value of the second evaluation result information and the third evaluation result information and the second evaluation result information and the third evaluation result information fall within a similar range.

6. The system evaluation apparatus according to claim 5,
wherein the one or more processors further:
output the second vulnerability tendency information relevant to the second evaluation result information when the evaluation value of the second evaluation result information is higher than the evaluation value of the first evaluation result information and the third evaluation result information and the first evaluation result information and the third evaluation result information fall within the similar range.

7. The system evaluation apparatus according to claim 6,
wherein the one or more processors further:
output third vulnerability tendency information relevant to the third evaluation result information when the evaluation value of the third evaluation result information is higher than the evaluation value of the first evaluation result information and the second evaluation result information and the first evaluation result information and the second evaluation result information fall within the similar range.

8. The system evaluation apparatus according to claim 7, wherein
the first vulnerability tendency information includes text information indicating that the number of vulnerabilities is averagely large,
the second vulnerability tendency information includes text information indicating that the information processing apparatus in which the number of vulnerabilities is in a risk range is present, and
the third vulnerability tendency information includes text information indicating that equal to or more than a preset number of the information processing apparatuses in which the number of vulnerabilities is large are present.

9. A system evaluation method causing
a computer to perform a process comprising:
evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods; and
causing an output device to output vulnerability tendency information that represents a tendency of the vulnerability relevant to a worst evaluation result of the evaluation result information for each of the evaluation methods.

10. A non-transitory computer-readable recording medium that includes a program recorded thereon, the program including instructions that causes to carry out:
evaluating, using detection result information that represents a detection result of a vulnerability included in a plurality of information processing apparatuses included in a system, a vulnerability status in the system for each of different types of evaluation methods and generating evaluation result information that represents an evaluation result for each of the evaluation methods; and
causing an output device to output vulnerability tendency information that represents a tendency of the vulnerability relevant to a worst evaluation result of the evaluation result information for each of the evaluation methods.
